(19) United States
(12) Patent Application Publication
(10) Pub. No.: US 2001/0027945 A1
(43) Pub. Date: Oct. 11, 2001

(54) Method of manufacturing a metallic filter

(75) Inventor: Naftali Sauerbrun, Northridge, CA (US)

Correspondence Address: Charanjit Brahma, PILLSBURY WINTHROP LLP, Suite 2800, 725 South Figueroa Street, Los Angeles, CA, 90017-5443, US

(73) Assignee: PTI TECHNOLOGIES, INC.

(21) Appl. No.: 09/878,551

(22) Filed: Jun. 11, 2001

Related U.S. Application Data
(62) Division of application No. 09/074,927, filed on May 6, 1998, now abandoned.

(51) Int. Cl. B01D 39/10

(52) U.S. Cl. 210/490; 210/496; 210/510.1

(57) ABSTRACT

A metallic filter for filtering a fluid includes a filter element. A structure of the filter element is strengthened by a heat treatment after assembly to resist ΔP changes in the fluid to minimize irreversible compression and degradation of the filter element due to the partial collapse of the filter element from a rise in the ΔP of the fluid passing through the filter element. Preferably, the filter element includes a non-woven, metallic mat. Also, the filter element include at least two metallic support screens, and the non-woven metallic mat is sandwiched between the at least two metallic support screens. In addition, the filter element is preferably formed from a material selected from stainless steel titanium, nickel, Carpenter 20 Cb-3, Hastelloy R and Hastelloy X. Further, the filter element is pleated and formed to surround a support member, and the heat treatment after assembly occurs after pleating and forming. In addition, the non-woven metallic mat includes metallic fibers, and is also heat treated before assembly to provide a first bonding of the metallic fibers.

### FIELD OF THE INVENTION

This invention relates to filters utilized in high ΔP fluid flows and, in particular embodiments, to a metallic filter and method of making the same that minimizes irreversible compression and degradation due to high ΔP fluid flows.

### BACKGROUND OF THE INVENTION

Traditionally, many filtering operations require a relatively inert filter that can withstand relatively high differential pressures “ΔP” (between the exterior of the filter and the interior of the filter), which are generally greater than 100 psi. The basic filtering element is formed from a metal, such as stainless steel, to withstand the ΔP and to resist corrosion of the filter element from contact with the fluid flow during the filtering process. Thus, these filters are used to filter (i.e., purify) various fluids prior to their use in other processes.

In some conventional filters, a non-woven stainless steel mat, that uses multiple and differing layers of single sized fibers, is used. Generally, to form the mat, a layer of unprocessed, single-size fibers is layered on another layer (or layers) to create a filter media that provides the desired filtering effect. For example, a layer of 12 micron diameter fibers can be layered onto a base layer of 8 micron diameter fibers, which is then in turn layered on another layer of 22 micron diameter fibers to form the non-woven mat. Thus, a filter element can mix the size of the fibers between layers. Generally, the only contact between different sized fibers is found at the interface between the individual layers. The size of the fibers in each layer are typically all of the same diameter.

After forming the non-woven stainless steel mat, the mat is generally processed by heat treatment in a hydrogen furnace to cause the fibers in the various layers that form the mat to “soft sinter” or bond together. The hydrogen furnace uses a hydrogen atmosphere at 1925° to 2100° Fahrenheit. Once the heat treatment is completed, the mat is calendered to the desired thickness for use in the filter element. The calendering process affects the overall strength and resiliency of the fiber contacts in the mat to be used in the filter element.

After calendering is completed, the mat is sandwiched between several layers of metallic screen to provide additional resiliency and support for the non-woven mat. Generally, there is a top screen, followed by the non-woven mat, and then followed by one, two or three additional support screens. Typically, in applications requiring a filtering efficiency of 60 microns or less, there are four layers used in the filtering element. In applications requiring a filtering efficiency greater than 60 microns, one of the support screens between the non-woven mat and the two support screens may be removed to form a filtering element using a total of three layers. In further applications, in an attempt to handle higher ΔP, an additional screen may be placed on the other support screens for a total of five layers.

Once the filtering material has been sandwiched together, one end is tack-welded to hold the sandwiched material together during further construction of the filter. The sandwiched material is then pleated, generally starting from the tack-welded end, to create the desired folds for the filtering element. After pleating, the pleated material is squeezed together to shorten the length of the pleated material to fit around a support tube or central core. Then the squeezed pleated material is wrapped around an arbor to verify the fit. The two adjoining ends of the wrapped around material are then seam-welded together to form a circular filter element for surrounding the support tube. Next, the exterior of the open ends of the filter element tube are rounded to receive weld rings. After the weld rings are positioned, the inner portion of the ends of the filter element are rounded to facilitate proper attachment of the weld rings. After this step, the weld rings couplings are welded to the filter element. Final assembly of the filter is accomplished by re-insertion of the support tube and by attaching further attachments to the weld rings that provide threads for connection and an end cap to seal off one end of the filter.

Drawbacks to this particular filter design is that these filters tend to have a reduced lifetime (on-line or cycles) under higher ΔP on the order of 500 psi or greater. At these ΔP, the filter element tends to bend and flex, which in turn causes irreversible compression in various areas of the filter element. In particular, bending and flexing occurs around the pleats, causing the non-woven material to irreversibly compress. This irreversible compression has been found to decrease the life expectancy of the filter for repeated cycles by 19% or more. As irreversible compression occurs, porosity decreases and the ΔP increases, which correspondingly causes shorter on-stream life. These filters are generally intended to be used multiple times; therefore, once the non-woven material has been irreversibly compressed, even cleaning the filter will not restore the filter element to its pre-filtration condition. In some filter designs, the repeated on-stream cycles of increased ΔP may deteriorate the filter elements along the folds in the pleats to further reduce the life of the filter element.

In an attempt to overcome the drawbacks associated with a non-woven mat, particular versions of the filter may use a non-woven mat that is “hard sintered” in a vacuum furnace; rather, than a hydrogen atmosphere furnace. This produces a stiffer non-woven mat filter element that is less malleable and might withstand somewhat greater ΔP. However the stiffer non-woven mat in the filter element is much more subject to breakage during folding and during the welding of end pieces, because of the lack of malleability. This breaks the bonds between hard sintered fibers and weakens the non-woven mat. In addition, the rejection of total filters increases during production, with potentially only a slightly greater life expectancy of the filter.

In another attempt to overcome the drawbacks, metal screens are used without the non-woven mat. However, although more resistant to compression and fracture, it is difficult to provide screen configurations that provide the required on-stream life that is obtainable with nonwoven mats.

### SUMMARY OF THE DISCLOSURE

It is an object of an embodiment of the present invention to provide an improved metallic filter and method of making the same, which obviates for practical purposes, the above mentioned limitations.

According to an embodiment of the invention, a metallic filter for filtering a fluid includes a filter element. A structure of the filter element is strengthened by a heat treatment after assembly to resist ΔP changes in the fluid to minimize irreversible compression and degradation of the filter element due to the partial collapse of the filter element from a rise in the ΔP of the fluid passing through the filter element. In preferred embodiments, the filter element includes a non-woven, metallic mat. Also, embodiments may include at least two metallic support screens, and the non-woven metallic mat is sandwiched between the at least two metallic support screens. In addition, the filter element is preferably formed from stainless steel, titanium, nickel, Carpenter 20 Cb-3, Hastelloy R or X or the like. Further, the filter element is pleated and formed to surround a support member, and the heat treatment after assembly occurs after pleating and forming around the support member. In addition, the non-woven metallic mat includes metallic fibers, and is also heat treated before assembly to provide a first bonding of the metallic fibers.

In other embodiments, the non-woven metallic mat includes a plurality of metallic fibers, and the heat treatment after assembly bonds the fibers in the non-woven metallic mat to each other, and bonds the at least two metallic support screens to the non-woven metallic mat. In particular, the filter element withstands at least 500 psi with less than 19%, 15% or 5% irreversible compression and degradation. In further alternatives, the filter element withstands at least 1000 psi with less than 19% irreversible compression and degradation.

In still other embodiment, the non-woven metallic mat includes a plurality of metallic fibers, and the heat treatment after assembly causes the fibers in the non-woven metallic mat to bond to each other. In particular, the filter element withstands at least 500 psi with less than 19%, 15% or 5% irreversible compression and degradation. In further alternatives, the filter element withstands at least 1000 psi with less than 19% irreversible compression and degradation.

Other features and advantages of the invention will become apparent from the following detailed description, taken in conjunction with the accompanying drawings which illustrate, by way of example, various features of embodiments of the invention.

### BRIEF DESCRIPTION OF THE DRAWINGS

A detailed description of embodiments of the invention will be made with reference to the accompanying drawings, wherein like numerals designate corresponding parts in the several figures.

FIG. 1 is a partially-exploded perspective view of a filter in accordance with a embodiment of the present invention.

FIG. 2 is a partial cross-sectional diagram conceptually showing pleats used in embodiments of a filter element.

FIG. 3 is a partial cut-away perspective view showing the makeup of the filter element material in accordance with an embodiment of the present invention.

FIG. 4 is a side view with a partial cross-section view of a filter in accordance with an embodiment of the present invention.

FIG. 5 is a flow diagram showing the method of manufacturing a filter in accordance with an embodiment of the present invention.

### DETAILED DESCRIPTION OF THE PREFERRED EMBODIMENTS

As shown in the drawings for purposes of illustration, the invention is embodied in an improved metallic filter. In preferred embodiments of the present invention, the metallic filters are used to filter fluids in chemical processes, such as the manufacturing of magnetic tapes, synthetic films, textile fibers, resins and specialty thermoplastics. However, it will be recognized that further embodiments of the invention may be used to filter other fluids, such as gases, gels and the like. Further embodiments may be used to filter fluids for other processes, such as semiconductor, medications, chemicals, coatings and the like.

As discussed above, one source of problems in conventional filters is that higher ΔP, on the order of 500 psi to 1000 psi (or even greater) are being used more and more commonly in chemical filtration processes. This trend appears to be continuing, as manufacturers try for greater efficiencies in the manufacturing process. Increased ΔP tend to compress the non-woven fiber structure (or in some manufacturer's designs crack the fibers) at the folds of the pleats in the non-woven mat that are used to form these filters. As irreversible compression occurs, the life of the filter is reduced. Thus, when the ΔP reach a certain level, the filter must be replaced for cleaning (or even replaced with a brand new filter). However, due to the prior irreversible compression of the non-woven mat in the filter due to the higher ΔP, upon cleaning the filter does not return to its original pre-filtering condition, and the resulting decreased porosity of the filter (due to the irreversible compressions providing less pathways), the filter experiences a shorter on-stream life cycle before reaching a threshold ΔP that requires replacement or cleaning of the filter.

Embodiments of the present invention continue to use a metallic, non-woven fiber mat in a filter element to overcome the deficiencies of metal screen only filters. However, the metallic, non-woven fiber mat is treated in an additional heat treatment step that strengthens the structure of the filter element of the filter to provide increased resistance to irreversible compression that shortens the life of the filter.

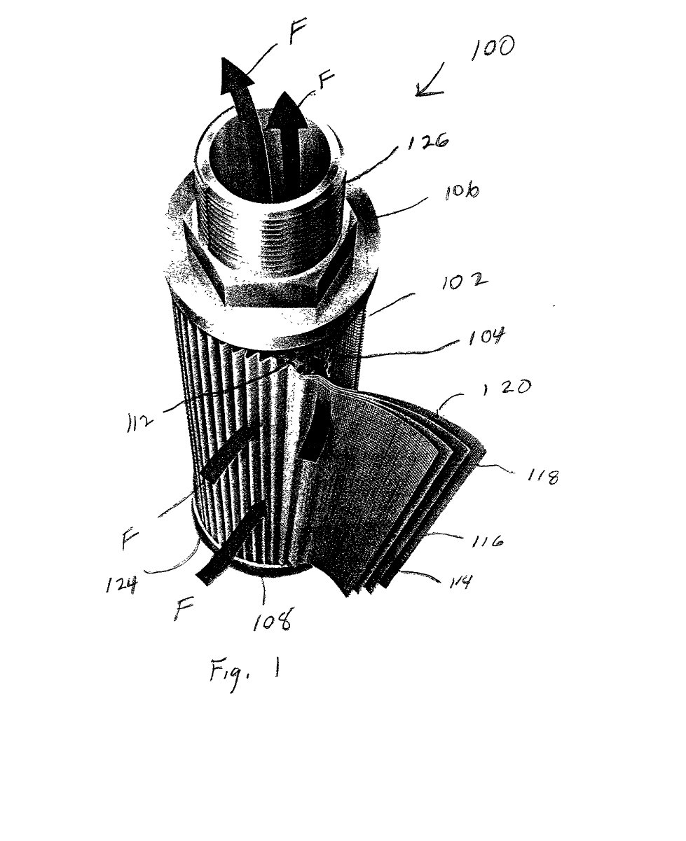

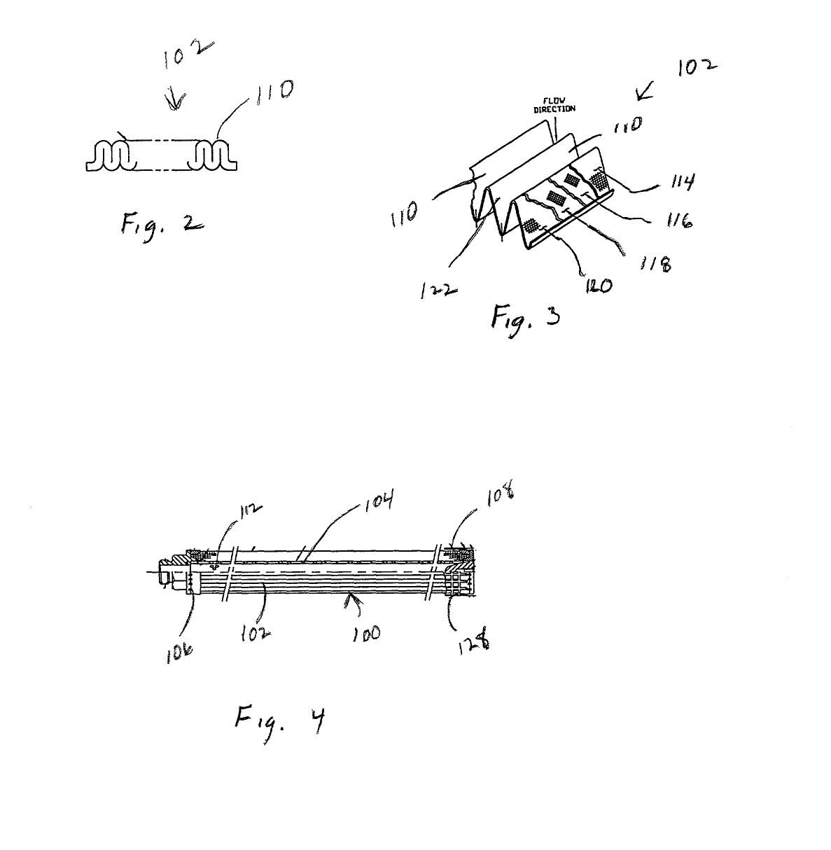

As shown in FIG. 1, a filter 100 in accordance with an embodiment of the present invention includes, a filter element 102, a support tube 104 and weld rings 106 and 108. The filter element 102 is generally pleated (see FIGS. 2 and 3) to form pleats 110 that provide additional filtering area to maximize the time between filter changes. The pleats 110 also provides space for fluid to flow (as shown by arrows F) through the filter 100 and enter the spaced openings 112 of the support tube 104. As shown in FIG. 3, the filter element 102 is formed from various layers.

In a preferred embodiment, the filter element 102 includes a coarse outside screen 114 as a first layer to protect a non-woven mat (or filter media) 116 from particulate impingement of high velocity particles, and which also acts as a fluid manifold. Next, the filter element 102 includes the non-woven mat 116 as a second layer, which acts as the filter media. After this, the filter element 102 includes a fine wire mesh screen 118 as a third layer that acts as an additional fluid flow manifold and provides for media separation. Finally, the filter element 102 includes a second coarse screen 120 as a fourth layer that acts as a fluid manifold to keep the exit flow path through the spaced openings 112 of the support tube 104 (see FIG. 1) open from the inside surface area of the non-woven mat 116. In alternative embodiments, additional screens may be used or omitted, with the requirements being dependent on the filtering efficiency of the filter and the anticipated ΔP to be encountered during the filtering process.

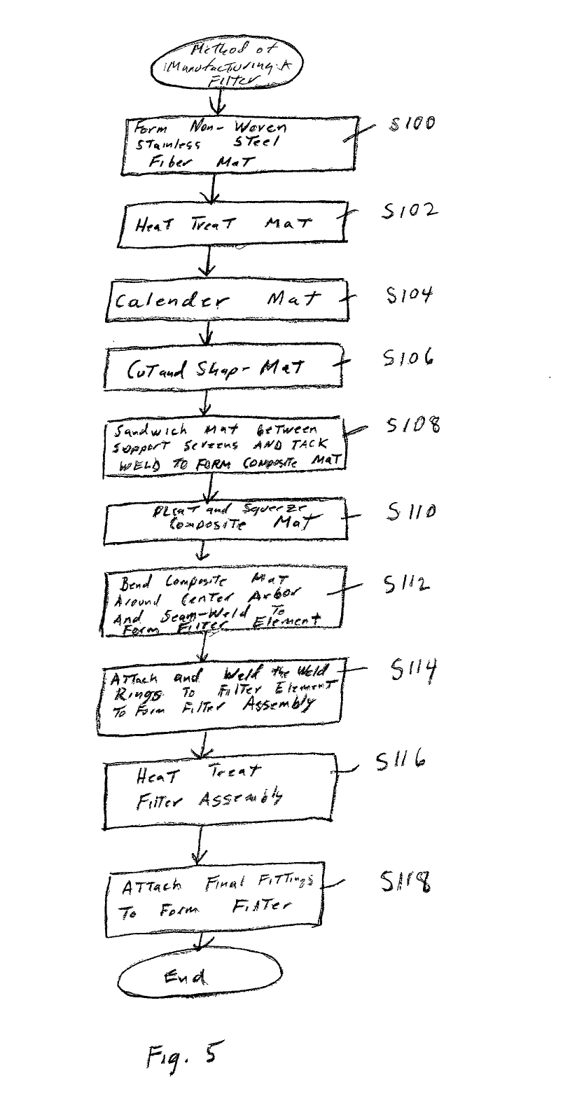

As shown in FIG. 5, the non-woven mat 116 is initially formed in a manner that produces a filter that is resistant to irreversible compression and the resulting degradation and shortened life. A non-woven mat 116 is formed of multiple layers of fibers in which each layer has the same size fibers and each of the different layers may have fibers of various sizes (see S100 of FIG. 5). In alternative embodiments, the fiber size may be varied with in each layer; rather than using just a single size fiber in each layer. In preferred embodiments, the fibers forming the layers of the non-woven mat 116 range in size from 1.5 to 30 microns to provide an overall filtering efficiency ranging from 0.5 to 80 microns. However, in alternative embodiments different fiber sizes, such as 0.1 to 1.5 microns, 20.1 to 50 microns and the like, may be used to produce different efficiency values.

Once the non-woven mat 115 has been formed with the desired number of layers, using the desired fiber sizes to yield the required filtering efficiency, the non-woven mat 116 is heat treated in a hydrogen furnace (with an pressure slightly greater than atmospheric pressure) at 1925 to 2100° Fahrenheit for 25 minutes to 1 hour (see Step S102 in FIG. 5). Next, the nonwoven mat 116 is calendered to produce the required thickness for the filter element 102 (see S104). Afterwards, the non-woven mat 116 is cut and shaped to the dimensions for producing the size filter element 102 to be formed (see S106). After this, the non-woven mat 116 is placed in a sandwiched composite mat 122 with the other three screen layers 114, 118 and 120 (see S108). In preferred embodiments, the coarse and fine screens 114, 118 and 120, and the nonwoven mat 116 are formed from stainless steel. However in alternative embodiments different metals such as titanium, nickel, Carpenter 20 Cb-3, Hastelloy R or X, or the like may be used with the choice being dependent on the filtering environment and the materials to be filtered.

The composite mat 122 is then pleated (see S110 of FIG. 5), and squeezed to shorten the material. The squeezed pleated material is then folded around an arbor to assure fit around the support tube 104 (see S112). Next, the adjoining free edges of the pleated and folded sandwiched composite mat 122 are then seam-welded (see S112). The outer surface of the ends of the pleated composite mat 122 are rolled to fit inside the weld rings 106 and 108. After which the composite mat 122 is coupled to weld rings 106 and 108. Next the inner surface of the ends of the composite mat 122 are rolled to assure contact with the weld rings 106 and 108, and to compact the non-woven mat 116 at the end of the filter element. The weld rings are then welded to the pleated and folded sandwiched composite mat 122 (see SI 14).

As shown in FIG. 5, embodiments of the present invention use an additional (or a second round of) heat treating at 1925-2100° Fahrenheit for an additional 25 minutes to one hour in a hydrogen furnace after manufacturing the pleated composite mat 122 and weld rings 106 and 108 of the entire filter element (see Step S116 in FIG. 5). In alternative embodiments, the additional heat treatment used is in a vacuum environment or other comparable heat treatment method. The purpose of this second (or additional) heat treatment is to repair and strengthen the broken sintering between fibers and fibers between the various layers in the non-woven mat 116 to rejoin them together and form a more solid, integral structure that is resistant to irreversible compression. In further embodiments, the second heat treating step (see S116) causes the wire screens 114, 118 and 120 to sinter together and bond with the non-woven mat 116 to provide a single composite, integral filter element 102 for additional structural strength and resistance to irreversible compression. This provides a very rigid and strong structure, either a strengthened non-woven mat 116 or a pleated and sandwiched composite mat 122, that is very resistant to higher ΔP on the order of 500 psi and above. In preferred embodiments, the filter can handle pressures of 1000-1500 psi, and suitable heat treatment and sintering and calendering between layers can increase the capabilities to much greater values of ΔP (on the order of 1500-3000 psi).

In particular embodiments, the loss of life due to irreversible compression is less than 19%. In preferred embodiments, the loss of life due to irreversible compression ranges from 5 to 15%; however, with proper heat treatment and selection of materials, it is possible to reduce the loss from irreversible compression to the range of 1 to 5%. The loss due to irreversible compression is defined as the reduction in life of the filter for each cycle of use after the first filtration cycle.

After the additional heat treatment, an end cap 124 and threaded fitting 126 are connected to the support tube 104 and weld rings 16 and 108, respectively, (see S118 of FIG. 5). An additional metal cage or guard shield 128 may be added to protect the filter element 102 during repeated cleaning and cycling in the apparatus by minimizing damaging dents and bangs to the filter element 102 (see FIG. 4).

The new structural strength that is found in these filter elements tends to resist compression and bending on higher fluid flows ΔP, since the fibers are further bonded, re-bonded (or sintered) together in the pleated structure, as opposed to some bonds being broken or weakened from the calendering, pleating, rolling and welding. Therefore, the filter element is better able to maintain near original filtering capacity over many cycles of filtering, which results in a longer life. If the screens 114, 118 and 120 are bonded (or sintered) to the non-woven mat 116, the entire structure becomes extremely resistant (as is found in laminates) to irreversible compression. As the filter element 102 accumulates contaminants, the ΔP will increase, but this will not tend to compress the non-woven mat 116, since the structure is much more rigid and resistant to irreversible compression. In addition, since there is a greater strength, there is an improved resistance to cracking or breakage at the folds of the pleats which would tend to render the filter inoperative after several cleaning cycles.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A metallic filter for filtering a fluid, the filter comprising:
a filter element for filtering the fluid, wherein a structure of the filter element has been strengthened by a heat treatment after assembly to resist ΔP changes in the fluid to minimize irreversible compression and degradation of the filter element due to partial collapse of the filter element from a rise in the ΔP of the fluid passing through the filter element.

2. A metallic filter according to claim 1, wherein the filter element includes a non-woven, metallic mat.

3. A metallic filter according to claim 2, wherein the filter element further includes at least two metallic support screens, and wherein the non-woven metallic mat is sandwiched between the at least two metallic support screens.

4. A metallic filter according to claim 3, wherein the filter element is formed from a material selected from the group consisting essentially of stainless steel titanium, nickel, Carpenter 20 Cb-3, Hastelloy R and Hastelloy X.

5. A metallic filter according to claim 3, wherein the non-woven metallic mat includes a plurality of metallic fibers, wherein the heat treatment after assembly bonds the fibers in the nonwoven metallic mat to each other, and wherein the heat treatment after assembly bonds the at least two metallic support screens to the non-woven metallic mat.

6. A metallic filter according to claim 5, wherein the filter element is pleated and formed to surround a support member, and wherein the heat treatment after assembly occurs after pleating and forming.

7. A metallic filter according to claim 5, wherein the filter element withstands at least 500 psi with less than 19% irreversible compression and degradation.

8. A metallic filter according to claim 5, wherein the filter element withstands at least 500 psi with less than 15% irreversible compression and degradation.

9. A metallic filter according to claim 5, wherein the filter element withstands at least 500 psi with less than 5% irreversible compression and degradation.

10. A metallic filter according to claim 5, wherein the filter element withstands at least 1000 psi with less than 19% irreversible compression and degradation.

11. A metallic filter according to claim 2, wherein the non-woven metallic mat includes a plurality of metallic fibers, and wherein the heat treatment after assembly causes the fibers in the non-woven metallic mat to bond to each other.

12. A metallic filter according to claim 11, wherein the filter element withstands at least 500 psi with less than 19% irreversible compression and degradation.

13. A metallic filter according to claim 11, wherein the filter element withstands at least 500 psi with less than 15% irreversible compression and degradation.

14. A metallic filter according to claim 11, wherein the filter element withstands at least 500 psi with less than 5% irreversible compression and degradation.

15. A metallic filter according to claim 11, wherein the filter element withstands at least 1000 psi with less than 19% irreversible compression and degradation.

16. A metallic filter according to claim 2, wherein the non-woven metallic mat include metallic fibers, and wherein the non-woven metallic mat is heat treated before assembly to provide a first bonding of the metallic fibers.

17. A method of manufacturing a metallic filter for filtering a fluid, the method comprising the steps of:
providing a filter element;
heat treating a structure of the filter element after assembly to strengthen the filter element to resist ΔP changes in the fluid to minimize irreversible compression and degradation of the filter element due to partial collapse of the filter element from a rise in the ΔP of the fluid passing through the filter element.

18. A method according to claim 17, further comprising the step of forming the filter element from a non-woven, metallic mat.

19. A method according to claim 18, further comprising the steps of:
providing at least two metallic support screens; and
sandwiching the non-woven metallic mat between the at least two metallic support screens.

20. A method according to claim 19, further comprising the step of forming the filter element from a material selected from the group consisting essentially of stainless steel titanium, nickel, Carpenter 20 Cb-3, Hastelloy R and Hastelloy X.

21. A method according to claim 19, wherein the non-woven metallic mat includes a plurality of metallic fibers, wherein the step of heat treating after assembly bonds the fibers in the nonwoven metallic mat to each other, and wherein the step of heat treating after assembly bonds the at least two metallic support screens to the non-woven metallic mat.

22. A method according to claim 21, further comprising the steps of:
pleating the filter element; and
forming the filter element to surround a support member before the heat treating after assembly step.

23. A method according to claim 21, further comprising the step of forming the filter element to withstand at least 500 psi with less 19% irreversible compression and degradation.

24. A method according to claim 21, further comprising the step of forming the filter element to withstand at least 500 psi with less than 15% irreversible compression degradation.

25. A method according to claim 21, further comprising the step of forming the filter element to withstand at least 500 psi with less than 5% irreversible compression and degradation.

26. A method according to claim 21, further comprising the step of forming the filter element to withstand at least 1000 psi with less than 19% irreversible compression and degradation.

27. A method according to claim 18, wherein the non-woven metallic mat includes a plurality of metallic fibers, and wherein the step of heat treating after assembly causes the fibers in the non-woven metallic mat to bond to each other.

28. A method according to claim 27, further comprising the step of forming the filter element to withstand at least 500 psi with less than 19% irreversible compression and degradation.

29. A method according to claim 27, further comprising the step of forming the filter element to withstand at least 500 psi with less than 15% irreversible compression and degradation.

30. A method according to claim 27, further comprising the step of forming the filter element to withstand at least 500 psi with less than 5% irreversible compression and degradation.

31. A method according to claim 27, further comprising the step of forming the filter element to withstand at least 1000 psi with less than 19% irreversible compression and degradation.

32. A method according to claim 18, where in the non-woven metallic mat include metallic fibers, and further comprising the step of heat treating the non-woven metallic mat before assembly to provide a first bonding of the metallic fibers.
